(19) United States
(12) Patent Application Publication
(10) Pub. No.: US 2024/0020351 A1
(43) Pub. Date: Jan. 18, 2024

(54) INFORMATION PROCESSING DEVICE

(71) Applicant: NEC Corporation, Minato-ku Tokyo (JP)

(72) Inventors: Shinji ITO, Tokyo (JP); Tatsuya MATSUOKA, Tokyo (JP); Naoto OHSAKA, Tokyo (JP)

(73) Assignee: NEC Corporation, Minato-ku Tokyo (JP)

(21) Appl. No.: 18/031,195

(22) PCT Filed: Oct. 14, 2020
(86) PCT No.: PCT/JP2020/038818

§ 371 Date: Apr. 11, 2023

(51) Int. Cl. G06F 17/18; G06F 17/16

(52) U.S. Cl. CPC G06F 17/18; G06F 17/16

(57) ABSTRACT

In order to enable derivation of useful subsets X₁, X₂, . . . , X_{T} also for an online submodular optimization problem for which a fixed strategy is not effective, an information processing apparatus (1) includes: an objective function setting unit (11) that sets, as an objective function fₜ in each round t∈[T], a submodular function on a power set 2^{S} of a set S consisting of n elements; and a subset sequence derivation unit (12) that derives a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁*, X₂*, . . . , Xₜ*∈2^{S} satisfying Σ_{t∈[T-1]}d_{H}(Xₜ*, Xₜ₊₁*) is not more than an upper limit Max (n,T,V).

### TECHNICAL FIELD

The present invention relates to an information processing apparatus that solves an online submodular optimization problem.

### BACKGROUND ART

Use of online submodular optimization is being considered in order to determine advertisements to be presented to a user regarding web advertising and to determine a product to be sold at a discount in web sales. Online submodular optimization refers to selecting a subset of a given set in each round in order to minimize or maximize a cumulative value of an objective function.

Examples of a known document related to online submodular minimization include Non-patent Literature 1. Patent Literature 1 discloses an algorithm for deriving subsets X₁, X₂, . . . , X_{T} that minimize an expected value of regret Σ_{t∈[T]}fₜ(Xₜ)−min_{X∈S}{Σ_{t∈[T]}fₜ(X)} to not more than O((nT)^{1/2}). Note here that fₜ represents an objective function in a round t.

### CITATION LIST

### Non-Patent Literature

[Non-patent Literature 1]

E. Hazan and S. Kale, “Online Submodular Minimization”, Journal of Machine Learning Research 13 (2012) 2903-2922

### SUMMARY OF INVENTION

### Technical Problem

In a method disclosed in Non-patent Literature 1, subsets X₁, X₂, . . . , X_{T} are derived in which an expected value of regret Σ_{t∈[T]}fₜ(Xₜ)−min_{X∈S}{Σ_{t∈[T]}fₜ(X)} is minimized to not more than O((nT)^{1/2}). This causes the following problem. Specifically, useful subsets X₁, X₂, . . . , X_{T} can be derived for an online submodular minimization problem for which a fixed strategy to select the same subset in all rounds is effective, whereas useful subsets X₁, X₂, . . . , X_{T} cannot be derived for online submodular minimization problem for which a fixed strategy is not effective. An online submodular maximization problem also has a similar problem.

An example aspect of the present invention has been made in view of the above problem, and an example object thereof is to provide an information processing apparatus that makes it possible to derive useful subsets X₁, X₂, . . . , X_{T} also for an online submodular optimization problem for which a fixed strategy is not effective.

### Solution to Problem

An information processing apparatus in accordance with an aspect of the present invention includes: an objective function setting means that sets, as an objective function f t in each round t∈[T] (T is any natural number), a submodular function on a power set 2^{S} of a set S consisting of n elements (n is any natural number); and a subset sequence derivation means that derives a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁*, X₂*, . . . , Xₜ*∈2^{S} satisfying Σ_{t∈[T-1]}d_{H}(Xₜ*, Xₜ₊₁*)≤V is not more than an upper limit Max (n,T,V) determined from n,T,V, assuming that V is a given integer not less than 0,

where d_{H}(Xₜ*,Xₜ₊₁*) is a Hamming distance between subsets, the Hamming distance being defined by d_{H}(Xₜ*,Xₜ₊₁*)=|Xₜ∪Xₜ₊₁*|−|Xₜ*∩Xₜ₊₁*|.

An information processing apparatus in accordance with an aspect of the present invention includes: an objective function setting means that sets, as an objective function fₜ in each round t∈[T] (T is any natural number), a normalized submodular function on a power set 2^{S} of a set S consisting of n elements (n is any natural number); and a subset sequence derivation means that derives a subset sequence X₁, X₂, . . . , X_{T} satisfying the following condition β1 or β2:

the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0,

the condition β2 being that the asymptotic behavior of the expected value of the α regret αΣ_{t∈[T]}fₜ(Xₜ*)−Σ_{t∈[T]}fₜ(Xₜ) with respect to the any benchmark X₁*, X₂*, . . . , Xₜ*∈2^{S} satisfying Σ_{t∈[T-1]}d_{H}(Xₜ*,Xₜ₋₁*) coincides with an asymptotic behavior of a function B (n,T,V) determined from n,T,V, assuming that V is a given integer not less than 0,

where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Advantageous Effects of Invention

An example aspect of the present invention makes it possible to provide an information processing apparatus that makes it possible to derive useful subsets X₁, X₂, . . . , X_{T} also for an online submodular optimization problem for which a fixed strategy is not effective.

### BRIEF DESCRIPTION OF DRAWINGS

FIG. 1 is a block diagram illustrating a configuration of an information processing apparatus in accordance with a first example embodiment.

FIG. 2 is a flow diagram showing a flow of an information processing method in accordance with the first example embodiment.

FIG. 3 is a flow diagram showing a first specific example of a subset sequence derivation process included in the information processing method shown in FIG. 2.

FIG. 4 is a flow diagram showing the first specific example of the subset sequence derivation process included in the information processing method shown in FIG. 2.

FIG. 5 is a block diagram illustrating a configuration of an information processing apparatus in accordance with a second example embodiment.

FIG. 6 is a flow diagram showing a flow of an information processing method in accordance with the second example embodiment.

FIG. 7 is a flow diagram showing a first specific example of a subset sequence derivation process included in the information processing method shown in FIG. 6.

FIG. 8 is a flow diagram showing the first specific example of the subset sequence derivation process included in the information processing method shown in FIG. 6.

FIG. 9 is a block diagram illustrating a configuration of a computer functioning as the information processing apparatus in accordance with the first example embodiment or the second example embodiment.

### BRIEF DESCRIPTION OF DRAWINGS

### First Example Embodiment

A first example embodiment of the present invention will be described in detail with reference to the drawings.

### Online Submodular Minimization Problem

Considered are (i) a set S consisting of n elements and (ii) an objective function fₜ: 2^{S}→I defined for each round t∈[T]. Note here that n and T each represent any natural number. [T] represents a set of natural numbers not less than 1 and not more than T. 2^{S} represents a power set of the set S, that is, a set consisting of all subsets of the set S. I represents a closed interval on a real number R. In the first example embodiment, it is assumed that I=[−1,1]. This assumption may affect expressions and values to be described below, but the present invention is not limited to the first example embodiment, and is therefore not limited by the assumption.

It is assumed that each objective function fₜ is a submodular function. That is, it is assumed that an inequality fₜ(X∪{i})−fₜ(X)≥ft(Y∪{i})−fₜ(Y) is satisfied for (i) any subset X,Y∈2^{S} satisfying X□Y and (ii) any element i∈S.

Among problems of selecting a subset sequence X₁, X₂, . . . , X_{T}∈2^{S}, a problem whose target is minimization of a cumulative value Σ_{t∈T}fₜ(Xₜ) of the objective function fₜ is referred to as an “online submodular minimization problem”. In the first example embodiment, the online submodular minimization problem is studied under the following full-information setting or bandit feedback setting.

Full-information setting: After selecting a subset Xₜ in a round t, it is possible to refer to a value fₜ(X) of the objective function fₜ with respect to any subset X∈2^{S}.

Bandit feedback setting: After selecting the subset Xₜ in the round t, it is (1) possible to refer to a value fₜ(Xₜ) of the objective function fₜ with respect to the selected subset Xₜ and (2) impossible to refer to a value fₜ(X) of the objective function fₜ with respect to a subset X∈2^{S} that is different from the selected subset.

### Configuration of Information Processing Apparatus

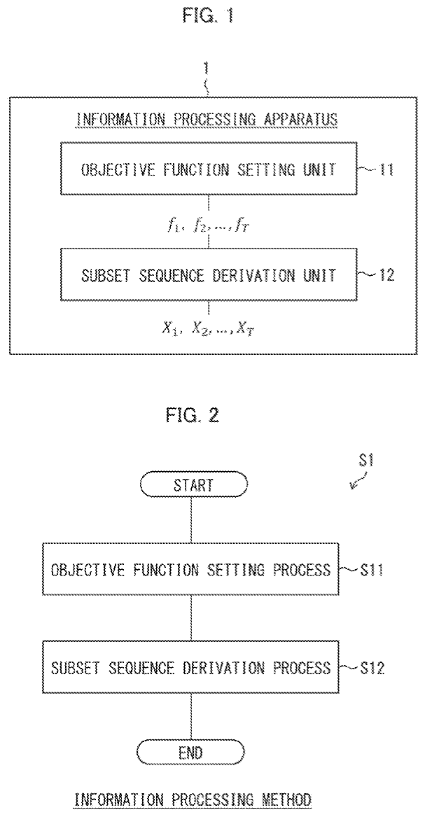

A configuration of an information processing apparatus 1 in accordance with the first example embodiment will be described with reference to FIG. 1. FIG. 1 is a block diagram illustrating a configuration of the information processing apparatus 1.

The information processing apparatus 1 is an apparatus for solving the online submodular minimization problem related to the set S consisting of the n elements. As illustrated in FIG. 1, the information processing apparatus 1 includes an objective function setting unit 11 and a subset sequence derivation unit 12.

The objective function setting unit 11 is a means that sets, as the objective function fₜ in each round t, a submodular function on the power set 2^{S} of the set S. The objective function setting unit 11 is an example of an “objective function setting means” in the claims. The submodular function that the objective function setting unit 11 sets as the objective function fₜ may be (i) predetermined, (ii) input by a user via a keyboard or the like, or (iii) input by another apparatus via a communication network or the like. The submodular function that the objective function setting unit 11 sets as the objective function fₜ may be generated in various processes carried out inside the information processing apparatus 1.

The subset sequence derivation unit 12 is a means that derives a subset sequence X₁, X₂, . . . , X_{T} satisfying a condition α below. The subset sequence derivation unit 12 is an example of a “subset sequence derivation means” in the claims. The subset sequence X₁, X₂, . . . , X_{T} that is derived by the subset sequence derivation unit 12 may be provided to a user via a display or the like, or may be provided to another apparatus via a communication network or the like. The subset sequence X₁, X₂, . . . , X_{T} that is derived by the subset sequence derivation unit 12 may be used in various processes carried out inside the information processing apparatus 1.

The condition α is that an expected value of regret Σ_{t∈[T]}fₜ(Xₜ)−Σ_{t∈[T]}fₜ(Xₜ*) with respect to any benchmark X₁*,X₂*, . . . ,Xₜ*∈2^{S} satisfying Σ_{t∈[T-1]}d_{H}(Xₜ*,Xₜ₊₁*) is not more than an upper limit Max (n,T,V) determined from n,T,V, assuming that V is a given integer not less than 0, where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Flow of Information Processing Method

A flow of an information processing method S1 in accordance with the first example embodiment will be described with reference to FIG. 2. FIG. 2 is a flow diagram showing the flow of the information processing method S1.

The information processing method S1 is a method for solving the online submodular minimization problem related to the set S consisting of the n elements. As illustrated in FIG. 2, the information processing method S1 includes an objective function setting process S11 and a subset sequence derivation process S12. The information processing method S1 is carried out by, for example, the information processing apparatus 1.

The objective function setting process S1 is a process for setting, as the objective function fₜ in the each round t, the submodular function on the power set 2^{S} of the set S. The objective function setting process S11 is carried out by, for example, the objective function setting unit 11 of the information processing apparatus 1. The subset sequence derivation process S12 is a process for deriving the subset sequence X₁, X₂, . . . , X_{T} satisfying the condition α shown in the previous section. The subset sequence derivation process S12 is carried out by, for example, the subset sequence derivation unit 12 of the information processing apparatus 1.

### Effect of Information Processing Apparatus and Information Processing Method

In the method disclosed in Non-patent Literature 1, subsets X₁, X₂, . . . , X_{T} that cause an expected value of regret Σ_{t∈[T]}fₜ(Xₜ)−min_{X∈S}{Σ_{t∈[T]}fₜ(X)} to be not more than an upper limit Max (n,T) determined in accordance with n,T. Thus, useful subsets X₁, X₂, . . . , X_{T} can be derived for the online submodular minimization problem for which a fixed strategy to select the same subset in all rounds is effective, whereas the useful subsets X₁, X₂, . . . , X_{T} cannot be derived for the online submodular minimization problem for which a fixed strategy is not effective.

In contrast, in the information processing apparatus 1 and the information processing method S1 in accordance with the first example embodiment, the subsets X₁, X₂, . . . , X_{T} are derived in which the expected value of the regret Σ_{t∈[T]}fₜ(Xₜ)−Σ_{t∈[T]}fₜ(Xₜ*) is not more than the upper limit Max (n,T,V) determined from n,T,V. In this case, a benchmark X₁*, X₂*, . . . , Xₜ* need only satisfy Σ_{t∈[T-]}d_{H}(Xₜ*,Xₜ₊₁*)≤V and need not be constant. It is therefore possible to derive the useful subsets X₁, X₂, . . . , X_{T} also for the online submodular minimization problem for which the fixed strategy is not effective.

### First Specific Example of Subset Sequence Derivation Process

The inventors of the present invention have succeeded in proving, regarding the online submodular minimization problem in full-information setting, the following theorem A.

Theorem A: If a subset sequence X₁, X₂, . . . , X_{T}∈2^{[n]} is a subset sequence derived by an algorithm shown in Table 1 below, the following inequality (1) holds true for the any benchmark X₁*, X₂*, . . . , Xₜ*∈2^{[n]}. This causes an asymptotic behavior of the expected value of the regret Σ_{t∈[T]}fₜ(Xₜ)−Σ_{t∈[T]}fₜ(Xₜ*) to coincide with an asymptotic behavior of {T(n+Σ_{t∈[T-1]}d_{H}(Xₜ*,Xₜ₊₁*))}^{1/2}. Note that the asymptotic behaviors are compared here in disregard of a polynomial of logT and a polynomial of logn.

$$E [ {\sum }_{t = 1}^{T} {f}_{t} ( {X}_{t} ) - {\sum }_{t = 1}^{T} {f}_{t} ( {X}_{t}^{*} ) ] \leq 4 \sqrt{T ( n + 2 {\sum }_{t = 1}^{T - 1} {d}_{H} ( {X}_{i}^{*} , {X}_{i + 1}^{*} ) )} + \sqrt{32 T log ( ⌈ log T ⌉ + 4 )} \qquad ( 1 )$$

where E[·] represents an expected value for internal randomness of the algorithm. Furthermore, ┌⋅┐ represents the smallest natural number not less than ⋅.

TABLE 1
Algorithm 1 An algorithm for online submodular minimization with full-information

Require: The number T of rounds and the size n of the ground set.

| | |
|---|---|
| 1: | $\begin{matrix}Set d = [ log T ] + 4 and let {p}_{1} = \frac{1}{d} 1 ∈ {Δ}^{d} . Set η = \sqrt{\frac{log d}{\text{?}}} . For each j ∈ [ d ] , initialize {x}_{t}^{( j )} by \\ {x}_{t}^{( j )} = 0 ∈ {a}^{} .\end{matrix}$ |
| 2: | for t = 1, 2, . . . , T do |
| 3: | Set xᵢ = Σⱼ₌₁^{d} pₜⱼxᵢ^{(j)}. |
| 4: | Pick uᵢ from a uniform distribution over [0, 1] and output Xᵢ = Hᵤᵢ (xᵢ) = {i ∈ [n] \| xᵤ ≥ uₜ}. |
| 5: | Get feedback of fₜ and compute gᵢ, a subgradient of fₜ at xᵢ. |
| 6: | for j = 1, 2, . . . , d do |
| 7: | $Compute {x}_{t + 1}^{( j )} as {x}_{t + 1}^{( j )} ∈ {arg min}_{\text{?}} {‖ x - {y}_{i + 1}^{( j )} ‖}_{2}^{2} , where {y}_{t + 1}^{( j )} = {x}_{t}^{( j )} - {η}^{( j )} {g}_{i} with {η}^{( j )} = \sqrt{\frac{η}{\text{?}}} .$ |
| 8: | end for |
| 9: | $Compute {p}_{i + 1} as {p}_{t + 1} = \frac{{w}_{i}}{‖ {w}_{t} ‖ t} with {w}_{ij} = exp ( - η {\sum }_{t - 1}^{t} {g}_{r}^{γ} {x}_{γ}^{( j )} ) ( j ∈ [ d ] ) .$ |
| 10: | end for |

$\text{?} \text{indicates text missing or illegible when filed}$

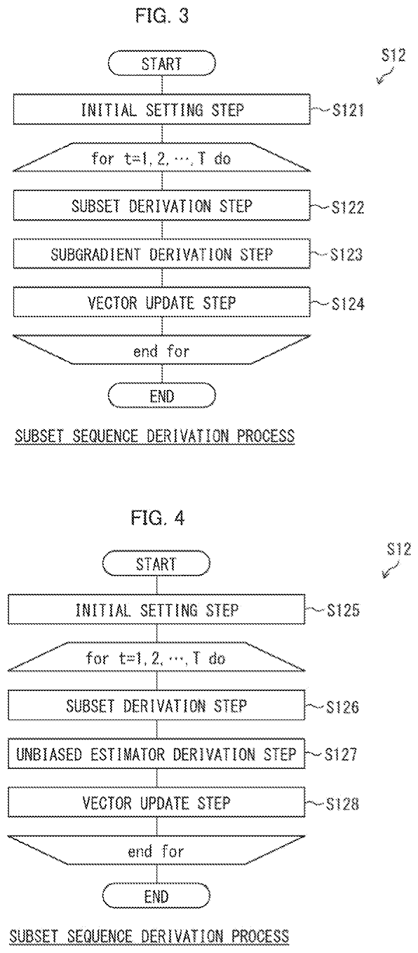

The following description will discuss, with reference to FIG. 3, a specific example of the subset sequence derivation process S12 which specific example is obtained by embodying the above theorem. Note that the following description identifies the set S consisting of the n elements with a set [n] of natural numbers={1,2, . . . , n}. Since elements of the set S and elements of the set [n] are in one-to-one correspondence, generality is not lost by such identification. The above theorem merely provides an example of the first example embodiment. The first example embodiment should not be construed as being limited to the theorem.

FIG. 3 is a flow diagram showing a flow of the subset sequence derivation process S12 in accordance with a specific example of the present invention. As shown in FIG. 3, the subset sequence derivation process S12 includes an initial setting step S121, a subset derivation step S122, a subgradient derivation step S123, and a vector update step S124. The subset derivation step S122, the subgradient derivation step S123, and the vector update step S124 are carried out for the each round t∈[T]. That is, these steps are repeatedly carried out T times.

In the subset sequence derivation process S12 in accordance with a specific example of the present invention, a natural number d, a real number η, and d real numbers η⁽¹⁾,η⁽²⁾, . . . , η^{(d)} are used as constants. Furthermore, a d-dimensional vector pₜ∈[0,1]^{d} satisfying ∥pₜ∥=1 an n-dimensional vector xₜ∈Rⁿ, and d n-dimensional vectors xₜ⁽¹⁾, xₜ⁽²⁾, . . . , xₜ^{(d)}∈Rⁿ are used as variables. Moreover, T real numbers u₁, u₂, . . . , u_{T} are used as respective random variables that are uniformly distributed on an interval [0,1].

The initial setting step S121 is a step of setting the constants d, η⁽¹⁾,η⁽²⁾, . . . , and η^{(d)} and initializing the vectors pₜ, xₜ⁽¹⁾,xₜ⁽²⁾, . . . , and xₜ^{(d)}. In the initial setting step S121, the subset sequence derivation unit 12 sets the constant d to, for example, a number obtained by adding 4 to the smallest natural number not less than logT. The subset sequence derivation unit 12 sets the constant η to, for example, η={logd/(8T)}^{1/2}. For each j∈[d], the subset sequence derivation unit 12 sets a constant η^{(j)} to, for example, η^{(j)}=(n/2^{j})^{1/2}. The subset sequence derivation unit 12 initializes the vector pₜ to, for example, p₁=(1/d,1/d, . . . , 1/d). For the each j∈[d], the subset sequence derivation unit 12 initializes a vector xₜ^{(j)} to, for example, xₜ^{(j)}=(0,0, . . . , 0).

The subset derivation step S122 is a step of deriving the subset Xₜ. In the subset derivation step S122, the subset sequence derivation unit 12 sets the vector xₜ first to, for example, xₜ=Σ_{j∈[d]}pₜⱼxₜ^{(j)}. Note here that pₜⱼ represents a jth component of the vector pₜ. Next, the subset sequence derivation unit 12 randomly sets a value of a random variable uₜ. Subsequently, the subset sequence derivation unit 12 derives the subset Xₜ defined by Xₜ={i∈[n]|xₜᵢ≥uₜ}. Note here that xₜᵢ represents an ith component of the vector xₜ.

The subgradient derivation step S123 is a step of deriving a subgradient gₜ at xₜ of the objective function fₜ. In the subgradient derivation step S123, it is possible to refer to the value fₜ(X) of the objective function fₜ with respect to any subset X∈[n]. In the subgradient derivation step S123, the subset sequence derivation unit 12 derives, for example, the subgradient gₜ defined by the following expression (2). In the following expression (2), o represents a permutation on the set [n] satisfying x_{tσ(1)}≥x_{tσ(2)}≥. . . ≥x_{tσ(n)}. S_{σ}(i) represents a subset of the set [n] which subset is defined by S_{σ}(i)={σ(j)|j∈[i]}. x(i)∈{0,1}ⁿ represents an indicator vector in which the ith component is 1 and a component that is different from the ith component is 0.

$${g}_{t} ( σ ) = {\sum }_{i = 1}^{n - 1} {f}_{t} ( {S}_{σ} ( i ) ) ( χ ( σ ( i ) ) - χ ( σ ( i + 1 ) ) ) + {f}_{t} ( [ n ] ) χ ( σ ( n ) ) \qquad ( 2 )$$

The vector update step S124 is a step of updating the vectors pₜ and Xₜ⁽¹⁾,xₜ⁽²⁾, . . . , xₜ^{(d)}. In the vector update step S124, the subset sequence derivation unit 12 updates the vector xₜ(j) in accordance with, for example, the following expression (3). The subset sequence derivation unit 12 updates the vector pₜ in accordance with, for example, the following expression (4).

$${y}_{t + 1}^{( j )} = {x}_{t}^{( j )} - {η}^{( j )} {g}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( 3 )$$

$${w}_{tj} = exp ( - η {\sum }_{τ ∈ [ t ]} {g}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( 4 )$$

As is clear from the theorem A, use of the subset sequence derivation process S12 in accordance with a specific example of the present invention enables the expected value of the regret Σ_{t∈[T]}fₜ(Xₜ)−Σ_{t∈[T]}fₜ(Xₜ*) with respect to the any benchmark X₁*, X₂*, . . . , Xₜ* satisfying Σ_{t∈[T-1]}d_{H}(Xₜ*,Xₜ₊₁*)≤V to be not more than the upper limit Max (n,T,V) defined by the following expression (5):

Max(n,T,V)=4\sqrt{T(n+2V)}+\sqrt{32Tlog(┌log T┐+4)} (5)

### Second Specific Example of Subset Sequence Derivation Process

The inventors of the present invention have succeeded in proving, regarding the online submodular minimization problem in bandit feedback setting, the following theorem B.

Theorem B: If the subset sequence X₁, X₂, . . . , X_{T}∈2^{[n]} is a subset sequence derived by an algorithm shown in Table 2 below, the following inequality (6) holds true for the any benchmark X₁*, X₂*, . . . , Xₜ*∈2^{[n]}. This causes the asymptotic behavior of the expected value of the regret Σ_{t∈[T]}fₜ(Xₜ)−Σ_{t∈[T]}fₜ(Xₜ*) to coincide with an asymptotic behavior of nT^{2/3}{(loglogT/n)^{1/2}+(1+Σ_{t∈[T-1]}d_{H}(Xₜ*,Xₜ₊₁*)/n)}.

$$E [ {\sum }_{t = 1}^{T} {f}_{t} ( {X}_{t} ) - {\sum }_{t = 1}^{T} {f}_{t} ( {X}_{t}^{*} ) ] \leq γ T + 4 ( n + 1 ) \sqrt{\frac{T}{γ}} ( 2 \sqrt{log log T} + \sqrt{n + {\sum }_{t = 1}^{T - 1} {d}_{H} ( {X}_{t}^{*} , {X}_{t + 1}^{*} )} ) \qquad ( 6 )$$

where γ represents a predetermined constant not less than 0 and not more than 1, the predetermined constant being called a search parameter.

TABLE 2
Algorithm 2 An algorithm for online submodular minimization with bandit feedback

Require: The number T of rounds, the size n of the base set, and the exploration parameter γ ∈ [0, 1].

| | |
|---|---|
| 1: | $\begin{matrix}Set d = 4 [ log T ] and let {p}_{1} = \frac{1}{d} 1 ∈ {Δ}^{d} . Set η = \sqrt{\frac{log d}{\text{?}}} . For each j ∈ [ d ] , initialize {x}_{t}^{( j )} by \\ {x}_{t}^{( j )} = 0 ∈ {a}^{} .\end{matrix}$ |
| 2: | for t = 1, 2, . . . , T do |
| 3: | Set xₜ = Σⱼ₌₁^{d} pₜⱼxₜ^{(j)}. |
| 4: | $\begin{matrix}Output {X}_{t} given by \\ {X}_{i} = \{ \begin{matrix}{H}_{{u}_{t}} ( {x}_{t} ) & ( {u}_{t} \sim Unif ( [ 0 , 1 ] ) ) & with probability ( 1 - γ ) \\ {S}_{σ} ( {s}_{t} ) & ( {s}_{i} \sim Unif ( \{ 0 , 1 , … , n \} ) ) & with probability γ\end{matrix} .\end{matrix}$ |
| | where S_{σ}(i) = {σ(j) \| j ∈ [i]}. |
| 5: | Observe fₜ(Xₜ) |
| 6: | $\begin{matrix}Compute {\hat{q}}_{t} given by \\ {\hat{q}}_{t} = \frac{1}{q \text{?}} {f}_{t} ( {X}_{t} ) ( χ ( σ ( {i}_{t} ) ) - χ ( σ ( {i}_{t} + 1 ) ) ) . \\ where \\ q \text{?} = γ \cdot \frac{1}{n + 1} + ( 1 - γ ) \cdot ( x \text{?} - {x}_{t , σ ( i + 1 )} )\end{matrix}$ |
| 7: | for j = 1, 2, . . . , d do |
| 8: | $Compute {x}_{t + 1}^{( j )} as {x}_{t + 1}^{( j )} ∈ {arg min}_{\text{?}} {‖ x - {y}_{i + 1}^{( j )} ‖}_{2}^{2} , where {y}_{t + 1}^{( j )} = {x}_{t}^{( j )} = {η}^{( j )} {\dot{g}}_{i} with {η}^{( j )} = \sqrt{\frac{η}{\text{?}}} .$ |
| 9: | end for |
| 10: | $Compute {p}_{i + 1} as {p}_{i + 1} = \frac{{x}_{t}}{\text{?}} with {ω}_{tj} = exp ( - η {\sum }_{t u 1}^{t} g \text{?} {x}_{t}^{( j )} ) ( j ∈ [ d ] ) .$ |
| 11: | end for |

$\text{?} \text{indicates text missing or illegible when filed}$

The following description will discuss, with reference to FIG. 4, a specific example of the subset sequence derivation process S12 which specific example is obtained by embodying the above theorem. Note that the following description identifies the set S consisting of the n elements with the set [n] of the natural numbers={1,2, . . . , n}. Since the elements of the set S and the elements of the set [n] are in one-to-one correspondence, generality is not lost by such identification. The above theorem merely provides an example of the first example embodiment. The first example embodiment should not be construed as being limited to the theorem.

FIG. 4 is a flow diagram showing a flow of the subset sequence derivation process S12 in accordance with a specific example of the present invention. As shown in FIG. 3, the subset sequence derivation process S12 includes an initial setting step S125, a subset derivation step S126, a subgradient derivation step S127, and a vector update step S128. The subset derivation step S126, the unbiased estimator derivation step S127, and the vector update step S128 are carried out for the each round t∈[T]. That is, these steps are repeatedly carried out T times.

In the subset sequence derivation process S12 in accordance with a specific example of the present invention, the natural number d, the real number η, and the d real numbers η⁽¹⁾, η⁽²⁾, . . . , η^{(d)} are used as constants. Furthermore, the d-dimensional vector pₜ∈[0,1]^{d} satisfying ∥pₜ∥=1, the n-dimensional vector xₜ∈Rⁿ, and the d n-dimensional vectors xₜ⁽¹⁾, xₜ⁽²⁾, . . . , xₜ^{(d)}∈Rⁿ are used as variables. Moreover, the T real numbers u₁, u₂, . . . , u_{T} are used as respective random variables that are uniformly distributed on the interval [0,1]. Further, T integers s₁, s₂, . . . , s_{T} are used as respective random variables that are uniformly distributed on {0,1, . . . , n}.

The initial setting step S125 is a step of setting the constants d, η⁽¹⁾,η⁽²⁾, . . . , and η^{(d)} and initializing the vectors pₜ, xₜ⁽¹⁾,xₜ⁽²⁾, . . . , and xₜ^{(d)}. In the initial setting step S125, the subset sequence derivation unit 12 sets the constant d to, for example, a number obtained by quadrupling the smallest natural number not less than logT. The subset sequence derivation unit 12 sets the constant η to, for example, η=[logd/{2(n+1)²T}]^{1/2}. For the each j∈[d], the subset sequence derivation unit 12 sets the constant η^{(j)} to, for example, η^{(j)}=(n/2^{j})^{1/2}. The subset sequence derivation unit 12 initializes the vector pₜ to, for example, p₁=(1/d,1/d, . . . ,1/d). For the each j∈[d], the subset sequence derivation unit 12 initializes the vector xₜ_{^{(j)}} to, for example, xₜ^{(j)}=(0,0, . . . , 0).

The subset derivation step S126 is a step of deriving the subset Xₜ. In the subset derivation step S126, the subset sequence derivation unit 12 sets the vector xₜ first to, for example, xₜ=Σ_{j∈[d]}pₜⱼxₜ^{(j)}. Note here that pₜⱼ represents the jth component of the vector pₜ. Next, the subset sequence derivation unit 12 randomly sets respective values of random variables uₜ,sₜ. Subsequently, the subset sequence derivation unit 12 derives the subset Xₜ defined by (1) Xₜ={i∈[n]|xₜᵢ≥uₜ} or derives the subset Xₜ defined by Xₜ={σ(j)|j∈[sₜ]}. Note here that xₜᵢ represents the ith component of the vector xₜ. Note also that σ represents the permutation on the set [n] satisfying x_{tσ(1)}≥x_{tσ(2)}≥. . . ≥x_{tσ(n)}. A probability with which a subset Xₜ={i∈[n]|xₜᵢ≥uₜ} is derived in the subset derivation step S126 is set to 1−γ. In other words, a probability with which Xₜ={σ(j)|j∈[sₜ]} is derived in the subset derivation step S126 is set to γ.

The unbiased estimator derivation step S127 is a step of deriving an unbiased estimator \hat{ }gₜ (with a symbol ∧ above gₜ) of the subgradient gₜ at xₜ of the objective function fₜ. In the unbiased estimator derivation step S127, it is possible to refer to only the value fₜ(Xₜ) of the objective function fₜ with respect to a subset Xₜ∈[n] derived in the subset derivation step S126. In the unbiased estimator derivation step S127, the subset sequence derivation unit 12 derives, for example, the unbiased estimator \hat{ }gₜ defined by the following expression (7). In the following expression (7), σ represents the permutation on the set [n] satisfying x_{tσ(1)}≥x_{tσ(2)}≥. . . ≥x_{tσ(n)}. qₜ represents a vector in which the ith component qₜᵢ is defined by qₜᵢ=γ/(1+n)+(1−γ)(x_{tσ(i)}−x_{tσ(i+1)}). iₜ represents a natural number satisfying Xₜ=S_{σ}(iₜ).

$${\hat{g}}_{t} = \frac{1}{{q}_{{ti}_{t}}} {f}_{t} ( {X}_{t} ) ( χ ( σ ( {i}_{t} ) ) - χ ( σ ( {i}_{t} + 1 ) ) ) \qquad ( 7 )$$

The vector update step S128 is a step of updating the vectors pₜ and xₜ⁽¹⁾,xₜ⁽²⁾, . . . ,xₜ^{(d)}. In the vector update step S128, the subset sequence derivation unit 12 updates the vector xₜ(j) in accordance with, for example, the following expression (8). The subset sequence derivation unit 12 updates the vector pₜ in accordance with, for example, the following expression (9).

$${y}_{t + 1}^{( j )} = {x}_{t}^{( j )} - {η}^{( j )} {\hat{g}}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( 8 )$$

$${w}_{tj} = exp ( - η {\sum }_{τ ∈ [ t ]} {\hat{g}}_{t}^{T} {x}_{τ}^{( j )} ) ( j ∈ [ d ] ) , {p}_{t + 1} = \frac{{w}_{t}}{{‖ {w}_{t} ‖}_{1}} \qquad ( 9 )$$

As is clear from the theorem B, use of the subset sequence derivation process S12 in accordance with a specific example of the present invention enables the expected value of the regret Σ_{t∈[T]}fₜ(Xₜ)−Σ_{t∈[T]}fₜ(Xₜ*) with respect to the any benchmark X₁*, X₂*, . . . , Xₜ* satisfying Σ_{t∈[T-1]}d_{H}(Xₜ*,Xₜ₊₁*)≤V to be not more than the upper limit Max (n,T,V) defined by the following expression (10):

$$Max ( n , T , V ) = γ T + 4 ( n + 1 ) \sqrt{\frac{T}{γ}} ( 2 \sqrt{log log T} + \sqrt{n + V} ) \qquad ( 10 )$$

### Second Example Embodiment

A second example embodiment of the present invention will be described in detail with reference to the drawings.

### Online Submodular Maximization Problem

Considered are (i) a set S consisting of n elements and (ii) an objective function fₜ:2^{S}→R_{≥0} defined for each round t∈[T]. Note here that n and T each represent any natural number. [T] represents a set of natural numbers not less than 1 and not more than T. 2^{S} represents a power set of a set S, that is, a set consisting of all subsets of the set S. R_{≥0} represents nonnegative real numbers as a whole. It is assumed that each objective function fₜ is a normalized submodular function.

Among problems of selecting a subset sequence X₁, X₂, . . . , X_{T}∈2^{S}, a problem whose target is maximization of a cumulative value Σ_{t∈T}fₜ(Xₜ) of the objective function fₜ is referred to as an “online submodular maximization problem”. In the second example embodiment, the online submodular maximization problem is studied under full-information setting (described earlier).

### Configuration of Information Processing Apparatus

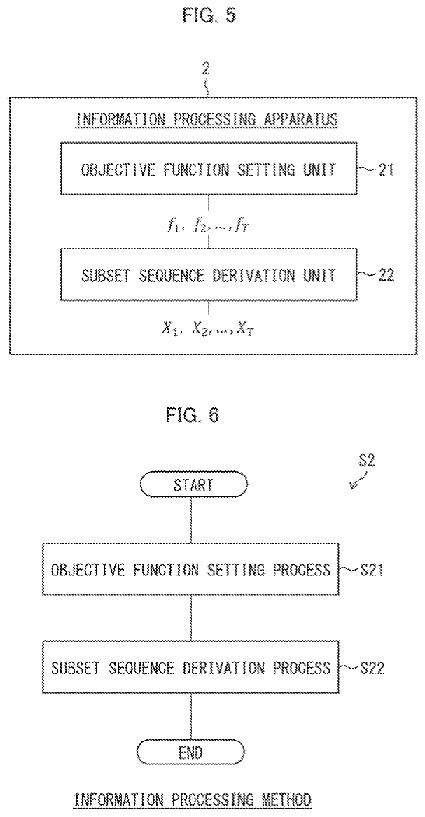

A configuration of an information processing apparatus 2 in accordance with the second example embodiment will be described with reference to FIG. 5. FIG. 5 is a block diagram illustrating a configuration of the information processing apparatus 2.

The information processing apparatus 2 is an apparatus for solving the online submodular maximization problem related to the set S consisting of the n elements. As illustrated in FIG. 5, the information processing apparatus 2 includes an objective function setting unit 21 and a subset sequence derivation unit 22.

The objective function setting unit 21 is a means that sets, as the objective function fₜ in the each round t, a submodular function on the power set 2^{S} of the set S. The objective function setting unit 21 is an example of the “objective function setting means” in the claims. The submodular function that the objective function setting unit 21 sets as the objective function fₜ may be (i) predetermined, (ii) input by a user via a keyboard or the like, or (iii) input by another apparatus via a communication network or the like. The submodular function that the objective function setting unit 21 sets as the objective function fₜ may be generated in various processes carried out inside the information processing apparatus 2.

The subset sequence derivation unit 22 is a means that derives a subset sequence X₁, X₂, . . . , X_{T} satisfying a condition β1 or β2 below. The subset sequence derivation unit 22 is an example of the “subset sequence derivation means” in the claims. The subset sequence X₁, X₂, . . . , X_{T} that is derived by the subset sequence derivation unit 22 may be provided to a user via a display or the like, or may be provided to another apparatus via a communication network or the like. The subset sequence X₁,X₂, . . . , X_{T} that is derived by the subset sequence derivation unit 22 may be used in various processes carried out inside the information processing apparatus 2.

The condition β1 is that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0.

The condition β2 is that the asymptotic behavior of the expected value of the α regret αΣ_{t∈[T]}fₜ(Xₜ*)−Σ_{t∈[T]}fₜ(Xₜ) with respect to the any benchmark X₁*,X₂*, . . . ,Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0.

### Information Processing Method

A flow of an information processing method S2 in accordance with the second example embodiment will be described with reference to FIG. 6. FIG. 6 is a flow diagram showing the flow of the information processing method S2.

The information processing method S2 is a method for solving the online submodular maximization problem related to the set S consisting of the n elements. As illustrated in FIG. 6, the information processing method S2 includes an objective function setting process S21 and a subset sequence derivation process S22. The information processing method S2 is carried out by, for example, the information processing apparatus 2.

The objective function setting process S21 is a process for setting, as the objective function fₜ in the each round t, the submodular function on the power set 2^{S} of the set S. The objective function setting process S21 is carried out by, for example, the objective function setting unit 21 of the information processing apparatus 2. The subset sequence derivation process S22 is a process for deriving the subset sequence X₁, X₂, . . . , X_{T} satisfying the condition β1 or β2 shown in the previous section. The subset sequence derivation process S22 is carried out by, for example, the subset sequence derivation unit 22 of the information processing apparatus 2.

### Effect of Information Processing Apparatus and Information Processing Method

In the information processing apparatus 2 and the information processing method S2 in accordance with the second example embodiment, subsets X₁, X₂, . . . , X_{T} in which the expected value of the α regret αΣ_{t∈[T]}fₜ(Xₜ*)−Σ_{t∈[T]}fₜ(Xₜ) is not more than an upper limit Max (k,T,V) or an upper limit Max (n,T,V) is derived. In this case, the benchmark X₁*, X₂*, . . . , Xₜ* need not be constant. It is therefore possible to derive useful subsets X₁, X₂, . . . , X_{T} also for online submodular maximization for which a fixed strategy is not effective.

### First Specific Example of Subset Sequence Derivation Process

The inventors of the present invention have succeeded in proving, regarding the online submodular maximization problem in full-information setting in which the number of elements of the subset Xₜ is fixed, the following theorem C.

Theorem C: If each objective function fₜ has monotonicity and a subset sequence X₁, X₂, . . . , X_{T}∈2^{[n]} constituted by a subset Xₜ consisting of k or less elements is a subset sequence derived by algorithms shown in Tables 3 and 4 below, the following evaluation formula (11) holds true for any benchmark X₁*, X₂*, . . . , Xₜ*∈2^{[n]} constituted by a subset Xₜ* consisting of k or less elements. Note here that the objective function fₜ having monotonicity means that fₜ(X)≤fₜ(Y) holds true for any subset X,Y∈∈2^{[n]} satisfying X□Y. Note also that O of Landau with a tilde above represents an asymptotic behavior in disregard of a polynomial of logT and a polynomial of logn.

$$E [ ( 1 - \frac{1}{e} ) {\sum }_{t = 1}^{T} {f}_{t} ( {X}_{t}^{*} ) - {\sum }_{t = 1}^{T} {f}_{t} ( {X}_{t} ) ] = \tilde{O} ( \sqrt{kT ( k + {\sum }_{t = 1}^{T - 1} {d}_{H} ( {X}_{t}^{*} , {X}_{t + 1}^{*} ) )} ) \qquad ( 11 )$$

TABLE 3
Algorithm 3 Algorithm for [symbol] submodular maxi [symbol] tion under size constraint

Require: The number [symbol] the base set [symbol] the size-constrained parameter [symbol] such that

[symbol]

| | [symbol] |
|---|---|
| 1: | Initialize [symbol] copies [symbol] (Algorithm 4) with parameters T and [symbol] |
| 2: | for [symbol] do |
| 3: | S [symbol] |
| 4: | for [symbol] do |
| 5: | Get the [symbol] output [symbol] |
| 6: | Draw an item [symbol] |
| 7: | [symbol] |
| 8: | end for |
| 9: | Output [symbol] |
| 10: | for [symbol] 1 [symbol] 2 [symbol] do |
| 11: | Set [symbol] for each [symbol] |
| 12: | [symbol] |
| 13: | end for |
| 14: | end for |

[symbol]

indicates data missing or illegible when filed

TABLE 4
Algorithm 4 FSF*

Require: The number T of rounds and the number n of actions.

| | |
|---|---|
| 1: | $\begin{matrix}[ Initialization step ] Set J = ⌈ log T ⌉ , η = \sqrt{\frac{log d}{T}} , and initialize {w}_{t} = {( {w}_{t 1} , {w}_{t 2} , … , {w}_{td} )}^{T} by {w}_{1 j} = 1 \\ for j = 1 , 2 , … , J . For j = 1 , 2 , … , J , set ( {η}^{( j )} , {a}^{( j )} ) = and initialize {w}_{t}^{( j )} = {( {w}_{t 1}^{( j )} , {w}_{t 2}^{( j )} , … , {w}_{tn}^{( j )} )}^{T} by \\ {w}_{1 i}^{( j )} = 1 for i = 1 , 2 , … , η .\end{matrix}$ |
| 2: | for t = 1, . . . T do |
| 3: | $Set {q}_{i} = \frac{{w}_{i}}{‖ {w}_{i} ‖} and {p}_{i}^{( j )} = \frac{w \text{?}}{‖ {w}_{i}^{( j )} ‖} for j = 1 , 2 , … , J .$ |
| 4: | [t~th output] Compute pₜ = Σⱼ₌₁j qᵢ^{j}pₜ^{(j)} and output pₜ. |
| 5: | [t~th input] Get feedback of [symbol] ₜ = ( [symbol] ₜ₁, [symbol] ₜ₂, . . . , [symbol] ₜₙ)^{T}. |
| 6: | for j = 1, 2, . . . , J do |
| 7: | Compute vₜᵢ^{(j)} = wₜᵢ^{(j)} exp(η^{(j)} [symbol] ₜᵢ) for i = 1, 2, . . . , n. |
| 8: | $Update {w}_{i}^{( j )} by {w}_{i + 1 d}^{( j )} = {α}^{( j )} \frac{w \text{?}}{n} + ( 1 - {α}^{( j )} ) {v}_{ti}^{( j )} for i = 1 , 2 , … , n where {W}_{i}^{( j )} = {v}_{tl}^{( j )} + … + {v}_{tn}^{( j )} .$ |
| 9: | Update wᵢⱼ by w_{i+1,j} = wᵢⱼ exp(η [symbol] ₜ^{T}pₜ^{(j)}). |
| 10: | end for |
| 11: | end for |

$\text{?} \text{indicates text missing or illegible when filed}$

Note that the algorithm shown in Table 4 includes J fixed share forecaster (FSF) algorithms corresponding to different η^{(j)}. Since each of the FSF algorithms is a publicly-known algorithm, a description thereof is omitted here. In the following description, {iₜ₁, iₜ₂, . . . , iₜₛ} is referred to as Xₜₛ, and {iₜ₁, iₜ₂, . . . , iₜₖ} is referred to as Xₜ. Furthermore, Xₜₛ∪{i_{t,s+1}} is referred to X_{t,s+1}, and fₜ(Xₜₛ∪{i})−fₜ(Xₜₛ) is referred to as lₜᵢ.

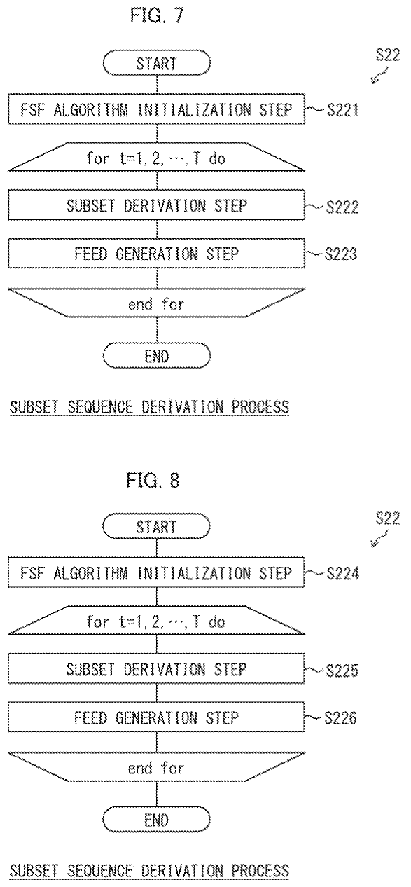

The following description will discuss, with reference to FIG. 7, a specific example of the subset sequence derivation process S22 which specific example is obtained by embodying the above theorem. Note that the following description identifies the set S consisting of the n elements with a set [n] of natural numbers={1,2, . . . , n}. Since elements of the set S and elements of the set [n] are in one-to-one correspondence, generality is not lost by such identification. The above theorem merely provides an example of the second example embodiment. The second example embodiment should not be construed as being limited to the theorem.

FIG. 7 is a flow diagram showing a flow of the subset sequence derivation process S22 in accordance with a specific example of the present invention. As shown in FIG. 7, the subset sequence derivation process S22 includes an FSF algorithm initialization step S221, a subset derivation step S222, and a feed generation step S223. The subset derivation step S222 and the feed generation step S223 are carried out for the each round t∈[T]. That is, these steps are repeatedly carried out T times.

The FSF algorithm initialization step S221 is a step of initializing, in accordance with the number T of rounds, k FSF algorithm execution modules FSF*⁽¹⁾, FSF*⁽²⁾, . . . , FSF*^{(k)} that execute the FSF algorithms.

The subset derivation step S222 is a step of deriving the subset Xₜ. In the subset derivation step S222, after setting Xₜ₀ to Xₜ₀=Ø, the subset sequence derivation unit 22 repeatedly carries out the following process for s=1,2, . . . , k. First, the subset sequence derivation unit 22 reads a vector pₜ^{(s)} that is output by an FSF algorithm execution module FSF*^{(s)}. Next, the subset sequence derivation unit 22 derives an element iₜₛ from the read vector pₜ^{(s)}. Subsequently, the subset sequence derivation unit 22 uses the derived element iₜₛ to generate Xₜₛ=X_{t,s-1}∪{iₜₛ}. The subset sequence derivation unit 22 derives a subset Xₜ=Xₜₖ by repeatedly carrying out the above process for s=1,2, . . . , k.

The feed generation step S223 is a step of generating feeds lₜ⁽¹⁾, lₜ⁽²⁾, . . . , lₜ^{(k)} to be input to the respective FSF algorithm execution modules FSF*⁽¹⁾, FSF*⁽²⁾, . . . , FSF*^{(k)}. In the feed generation step S223, the subset sequence derivation unit 22 generates, in accordance with lₜᵢ^{(s)}=fₜ(X_{t,s-1}∪{i})−fₜ(X_{t,s-1})(i∈[n]), a feed lₜ^{(s)}=(lₜ₁^{(s)},lₜ₂^{(s)}, . . . ,lₜₙ^{(s)}) to be input to the FSF algorithm execution module FSF^{*(s)}.

As is clear from the theorem C, use of the subset sequence derivation process S22 in accordance with a specific example of the present invention enables an asymptotic behavior of an expected value of (1−1/e) regret (1−1/e)Σ_{t∈[T]}fₜ(Xₜ*)−Σ_{t∈[T]}fₜ(Xₜ) with respect to the any benchmark X₁*,X₂*, . . . , Xₜ*∈2^{[n]} satisfying Σ_{t∈[T-1]}d_{H}(Xₜ*,Xₜ₊₁*)≤V and constituted by the subset Xₜ* consisting of the k or less elements to coincide with the asymptotic behavior of the function A (k,T,V) represented by the following expression (12):

A(k,T,V)=\sqrt{kT(k+V)} (12)

### Second Specific Example of Subset Sequence Derivation Process

The inventors of the present invention have succeeded in proving, regarding the online submodular maximization problem in full-information setting in which the number of elements of the subset Xₜ is not fixed, the following theorem D.

Theorem D: If a subset sequence X₁, X₂, . . . , X_{T}∈2^{[n]} is a subset sequence derived by an algorithm shown in Table 5 below, the following evaluation formula (13) holds true for the any benchmark X₁*, X₂*, . . . , Xₜ*∈2^{[n].}

$$E [ \frac{1}{2} {\sum }_{t = 1}^{T} {f}_{t} ( {X}_{t}^{*} ) - {\sum }_{t = 1}^{T} {f}_{t} ( {X}_{t} ) ] = \tilde{O} ( n \sqrt{T ( 1 + \frac{1}{n} {\sum }_{t = 1}^{T - 1} {d}_{H} ( {X}_{t}^{*} , {X}_{t + 1}^{*} ) )} ) \qquad ( 13 )$$

TABLE 5
Algorithm 5 Algorithm for [symbol] Submodular Max

[symbol]

Require: The number [symbol] of rounds, the size [symbol] of the

[symbol]

| | |
|---|---|
| 1: | Initialize [symbol] copies [symbol] (Algorithm 4) with parameters [symbol] and 2. |
| 2: | for [symbol] = 1 [symbol] do |
| 3: | Set [symbol] |
| 4: | for s = [symbol] do |
| 5: | Get the [symbol] output [symbol] from [symbol] and set [symbol] |
| 6: | With probability [symbol] set [symbol] Otherwise, (with probability |
| | [symbol] |
| 7: | end for |
| 8: | Output [symbol] and get feedback of [symbol] |
| 9: | for [symbol] do |
| 10: | Set [symbol] |
| 11: | Set [symbol] |
| 12: | [symbol] as the [symbol] input [symbol] |
| 13: | end for |
| 14: | end for |

[symbol]

indicates data missing or illegible when filed

The following description will discuss, with reference to FIG. 8, a specific example of the subset sequence derivation process S22 which specific example is obtained by embodying the above theorem. Note that the following description identifies the set S consisting of the n elements with the set [n] of the natural numbers={1,2, . . . , n}. Since the elements of the set S and the elements of the set [n] are in one-to-one correspondence, generality is not lost by such identification. The above theorem merely provides an example of the second example embodiment. The second example embodiment should not be construed as being limited to the theorem.

FIG. 8 is a flow diagram showing a flow of the subset sequence derivation process S22 in accordance with a specific example of the present invention. As shown in FIG. 7, the subset sequence derivation process S22 includes an FSF algorithm initialization step S224, a subset derivation step S225, and a feed generation step S226. The subset derivation step S225 and the feed generation step S226 are carried out for the each round t∈[T]. That is, these steps are repeatedly carried out T times.

The FSF algorithm initialization step S224 is a step of initializing, in accordance with the number T of rounds, n FSF algorithm execution modules FSF*⁽¹⁾, FSF*⁽²⁾, . . . , FSF*⁽ⁿ⁾ that execute the FSF algorithms.

The subset derivation step S225 is a step of deriving the subset Xₜ. In the subset derivation step S225, after setting Xₜ₀ to Xₜ₀=Ø and setting Yₜ₀ to Yₜ₀=[n], the subset sequence derivation unit 22 repeatedly carries out the following process for s=1,2, . . . , n. First, the subset sequence derivation unit 22 reads the vector pₜ^{(s)} that is output by the FSF algorithm execution module FSF*^{(s)} and sets qₜ^{(s)} to qₜ^{(s)}=(1+2pₜ₁^{(s)})/4. Next, with a probability qₜ^{(s)}, the subset sequence derivation unit 22 sets Xₜₛ to Xₜₛ=X_{t,s-1}∪{s} and sets Yₜₛ to Yₜₛ=Y_{t,s-1}. Otherwise, the subset sequence derivation unit 22 sets Xₜₛ to Xₜₛ=X_{t,s-1} and sets Yₜₛ to Yₜₛ=Y_{t,s-1}\{s}. The subset sequence derivation unit 22 derives the subset Xₜ=Xₜₙ=Yₜₙ by repeatedly carrying out the above process for s=1,2, . . . ,k.

The feed generation step S226 is a step of generating the feeds lₜ⁽¹⁾,lₜ⁽²⁾, . . . ,lₜ^{(k)} to be input to the respective FSF algorithm execution modules FSF*⁽¹⁾,FSF*⁽²⁾, . . . ,FSF*^{(k)}. In the feed generation step S226, the subset sequence derivation unit 22 sets αₜₛ to αₜₛ=fₜ(X_{t,s-1}∪{s})−fₜ(X_{t,s-1}) and sets βₜₛ to αₜₛ=fₜ(Y_{t,s-1}\{s})−fₜ(Y_{t,s-1}). The subset sequence derivation unit 22 generates, in accordance with lₜᵢ^{(s)}=(1−qₜ^{(s)})αₜₛ and lₜ₂^{(s)}=qₜ^{(s)}βₜₛ, a feed lₜ^{(s)}=(lₜ₁^{(s)},lₜ₂^{(s)}) to be input to the FSF algorithm execution module FSF*^{(s)}.

As is clear from the theorem D, use of the subset sequence derivation process S22 in accordance with a specific example of the present invention enables an asymptotic behavior of an expected value of (½) regret (½)Σ_{t∈[T]}fₜ(Xₜ*)−Σ_{t∈[T]}fₜ(Xₜ) with respect to the any benchmark X₁*, X₂*, . . . , Xₜ*∈2^{[n]} satisfying _{t∈[T-1]}d_{H}(Xₜ*,Xₜ₊₁*)≤V to coincide with an asymptotic behavior of a function B (k,T,V) represented by the following expression (14):

B(n,T,V)=\sqrt{T(1+V/n)} (14)

### Software Implementation Example

Some or all of functions of the information processing apparatus 1 or 2 can be realized by hardware provided in an integrated circuit (IC chip) or the like or can be alternatively realized by software. In the latter case, the functions of the units of the information processing apparatus 1 or 2 are realized by, for example, a computer that executes instructions of a program that is software.

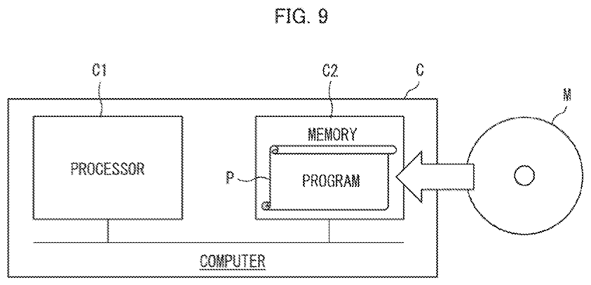

FIG. 9 illustrates an example of such a computer (hereinafter referred to as a “computer C”). As illustrated in FIG. 9, the computer C includes at least one processor C1 and at least one memory C2. The at least one memory C2 stores a program P for causing the computer C to operate as the information processing apparatus 1 or 2. In the computer C, the at least one processor C1 reads and executes the program P stored in the at least one memory C2, so that the functions of the units of the information processing apparatus 1 or 2 are realized.

Examples of the at least one processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is to be loaded while being executed and in which various kinds of data are to be temporarily stored. The computer C may further include a communication interface through which data is to be transmitted and received between the computer C and at least one other apparatus. The computer C may further include an input/output interface through which (i) an input apparatus(s) such as a keyboard and/or a mouse and/or (ii) an output apparatus(s) such as a display and/or a printer is/are to be connected to the computer C.

The program P can be recorded in a non-transitory, tangible storage medium M capable of being read by the computer C. Examples of such a storage medium M encompass a tape, a disk, a card, a semiconductor memory, and a programmable logic circuit. The computer C can acquire the program P via the storage medium M. The program P can alternatively be transmitted via a transmission medium. Examples of such a transmission medium encompass a communication network and a broadcast wave. The computer C can alternatively acquire the program P via the transmission medium.

### Application Example

The information processing apparatus 1 or 2 described earlier is applicable to various problems. An example of this is shown below.

### Retail

It is assumed that a measure is to reduce the respective beer prices of companies in a certain store. For example, in a case where an implemented measure Xₜ=[0,2,1, . . . ], it is assumed that a first element indicates setting of a beer price of a company A to a fixed price, a second element indicates a 10% increase in a beer price of a company B from a fixed price, and a third element indicates a 10% reduction in a beer price of a company C from a fixed price.

The objective function fₜ regards the implemented measure Xₜ as an input and regards, as an output, a result obtained by applying the implemented measure X to the respective beer prices of the companies to carry out sales. In this case, application of the above-described optimization method makes it possible to derive optimum setting of the respective beer prices of the companies in the above store.

### Investment Portfolio

The following description will discuss a case of application to an investment activity of, for example, an investor. In this case, it is assumed that the implemented measure Xₜ is investment (purchase, capital increase) with respect to a plurality of financial products (stock brands, etc.) held or to be held by the investor, or selling or holding of the plurality of financial products. For example, in a case where the implemented measure Xₜ=[1,0,2, . . . ], it is assumed that the first element indicates additional investment in stocks of a company A, the second element indicates holding (neither purchasing nor selling) receivables of a company B, and the third element indicates selling stocks of a company C. The objective function fₜ regards the implemented measure Xₜ as the input and regards, as the output, a result obtained by applying the implemented measure Xₜ to the investment activity with respect to financial products of the companies.

In this case, application of the above-described optimization method makes it possible to derive an optimum investment activity of the investor with respect to each brand.

### Clinical Trial

The following description will discuss a case of application to an administration activity for a clinical trial of a certain drug of a pharmaceutical company. In this case, it is assumed that the implemented measure Xₜ is a dose of administration or avoidance of administration. For example, in a case where the implemented measure Xₜ=[1,0,2, . . . ], it is assumed that the first element indicates that administration in a dose 1 is carried out with respect to a subject A, the second element indicates that administration is not carried out with respect to a subject B, and the third element indicates that administration in a dose 2 is carried out with respect to a subject C. The objective function fₜ regards the implemented measure Xₜ as the input and regards, as the output, a result obtained by applying the implemented measure Xₜ to the administration activity with respect to each of the subjects.

In this case, application of the above-described optimization method makes it possible to derive an optimum administration activity with respect to each of the subjects in the clinical trial of the pharmaceutical company.

### Web Marketing

The following description will discuss a case of application to an advertising activity (marketing measure) in an operating company of a certain electronic commerce site. In this case, it is assumed that the implemented measure Xₜ is advertising (an online (banner) advertisement, advertising by electronic mail, direct mail, electronic mail transmission of a discount coupon, etc.), with respect to a plurality of customers, for a product or service to be sold by the operating company. For example, in a case where the implemented measure Xₜ=[1,0,2, . . . ], it is assumed that the first element indicates a banner advertisement with respect to a customer A, the second element indicates that advertising is not carried out with respect to a customer B, and the third element indicates electronic mail transmission of a discount coupon to a customer C. The objective function fₜ regards the implemented measure Xₜ as the input and regards, as the output, a result obtained by applying the implemented measure Xₜ to the advertising activity with respect to each of the customers. Note here a result of implementation may be whether or not a banner advertisement has been clicked, a purchase amount, a purchase probability, or an expected value of the purchase amount.

In this case, application of the optimization method of the second example embodiment makes it possible to derive an optimum advertising activity of the operating company with respect to each of the customers.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### Supplementary Note 1

An information processing apparatus including:
an objective function setting means that sets, as an objective function fₜ in each round t∈[T] (T is any natural number), a submodular function on a power set 2^{S} of a set S consisting of n elements (n is any natural number); and
a subset sequence derivation means that derives a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁*, X₂*, . . . , Xₜ*∈2^{S} satisfying Σ_{t∈[T-1]}d_{H}(Xₜ*,Xₜ₊₁*)≤V is not more than an upper limit Max (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 2

The information processing apparatus according to Supplementary note 1, wherein
after deriving a subset Xₜ in a round t, the subset sequence derivation means is capable of referring to a value fₜ(X) of the objective function fₜ with respect to any subset X∈2^{S}, and
the upper limit Max (n,T,V) is given by the following expression (a):

Max(n,T,V)=4\sqrt{T(n+2V)}+\sqrt{32Tlog(┌logT┐+4)} (a)

### Supplementary Note 3

The information processing apparatus according to Supplementary note 2, wherein
the subset sequence derivation means uses (i) a d-dimensional vector pₜ∈[0,1]^{d} (d is a maximum natural number not exceeding logT+4) satisfying |pₜ|=1 and (ii) d n-dimensional vectors xₜ⁽¹⁾, xₜ⁽²⁾, . . . , xₜ^{(d)}∈Rⁿ to carry out, in each round,
a subset derivation step of using a randomly selected uₜ∈[0,1] to derive the subset Xₜ={i∈[n]|xₜᵢ≥uₜ}, assuming that pₜⱼ is a jth component of the vector pₜ, xₜ is an n-dimensional vector defined by xₜ=Σ_{j∈}pₜⱼxₜ^{(j)}, and xₜᵢ is an ith component of the vector xₜ,
a subgradient derivation step of deriving a subgradient gₜ at xₜ of the objective function fₜ, and
a vector update step of updating the vectors xₜ⁽¹⁾, xₜ⁽²⁾, . . . , xₜ^{(d)} in accordance with the following expression (a1) and updating the vector pₜ in accordance with the following expression (a2):

$${y}_{t + 1}^{( j )} = {x}_{t}^{( j )} - {η}^{( j )} {g}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( a1 )$$

where η(j) is a constant determined in accordance with n,

$${w}_{tj} = exp ( - η {\sum }_{τ ∈ [ t ]} {g}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( a2 )$$

where η is a constant determined in accordance with d and T.

### Supplementary Note 4

The information processing apparatus according to Supplementary note 1, wherein
after selecting a subset Xₜ in a round t, the subset sequence derivation means is (1) capable of referring to a value fₜ(Xₜ) of the objective function fₜ with respect to the selected subset Xₜ and (2) incapable of referring to a value fₜ(X) of the objective function fₜ with respect to a subset X∈2^{S} that is different from the selected subset, and
the upper limit Max (n,T,V) is given by the following expression (b):

$$Max ( n , T , V ) = γ T + 4 ( n + 1 ) \sqrt{\frac{T}{γ}} ( 2 \sqrt{log log T} + \sqrt{n + V} ) \qquad ( b )$$

where γ is a predetermined constant not less than 0 and not more than 1.

### Supplementary Note 5

The information processing apparatus according to Supplementary note 4, wherein
the subset sequence derivation means uses (i) a d-dimensional vector pₜ∈[0,1]^{d} (d is a maximum natural number not exceeding 4logT) satisfying |pₜ|=1 and (ii) d n-dimensional vectors xₜ⁽¹⁾, xₜ⁽²⁾, . . . , xₜ^{(d)}∈Rⁿ to carry out, in each round,
a subset derivation step of (1) using a randomly selected uₜ∈[0,1] to derive the subset Xₜ={i∈[n]|xₜᵢ≥uₜ} or (2) using a permutation σ on a set [n] satisfying x_{tσ(1)}≥x_{tσ(2)}≥. . . ≥x_{tσ(n)} and a randomly selected sₜ{0,1, . . . , n} to derive the subset Xₜ={σ(j)|j∈[sₜ]}, assuming that pₜⱼ is a jth component of the vector pₜ, xₜ is an n-dimensional vector defined by xₜ=Σ_{j∈}pₜⱼxₜ^{(j)}, and xₜᵢ is an ith component of a vector tx, the subset Xₜ={i∈[n]|xₜᵢ≥uₜ} being derived with a probability of 1−γ, the subset Xₜ={σ(j)|j∈[sₜ]} being derived with a probability of γ,
an unbiased estimator derivation step of deriving an unbiased estimator \hat{ }gₜ (\hat{ }g is a symbol with ∧ above g) of a subgradient gₜ at xₜ of the objective function fₜ, and
a vector update step of updating the vectors xₜ⁽¹⁾, xₜ⁽²⁾, . . . , xₜ^{(d)} in accordance with the following expression (b1) and updating the vector pₜ in accordance with the following expression (b2):

$${y}_{t + 1}^{( j )} = {x}_{t}^{( j )} - {η}^{( j )} {\hat{g}}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( b 1 )$$

where η^{(j)} is a constant determined in accordance with n,

$${w}_{tj} = exp ( - η {\sum }_{τ ∈ [ t ]} {\hat{g}}_{t}^{T} {x}_{τ}^{( j )} ) ( j ∈ [ d ] ) , {p}_{t + 1} = \frac{{w}_{t}}{{‖ {w}_{t} ‖}_{1}} \qquad ( b2 )$$

where η is a constant determined in accordance with n, d, and T.

### Supplementary Note 6

An information processing apparatus including:
an objective function setting means that sets, as an objective function fₜ in each round t∈[T] (T is any natural number), a submodular function on a power set 2^{S} of a set S consisting of n elements (n is any natural number); and
a subset sequence derivation means that derives a subset sequence X₁, X₂, . . . , X_{T}∈2^{S},
the subset sequence derivation means using (i) a d-dimensional vector pₜ∈[0,1]^{d} (d is a maximum natural number not exceeding logT+4) satisfying |pₜ|=1 and (ii) d n-dimensional vectors xₜ⁽¹⁾, xₜ⁽²⁾, . . . , xₜ^{(d)}∈Rⁿ to carry out, in each round,
a subset derivation step of using a randomly selected uₜ∈[0,1] to derive a subset Xₜ={i∈[n]|xₜᵢ≥uₜ}, assuming that pₜⱼ is a jth component of the vector pₜ, xₜ is an n-dimensional vector defined by xₜ=Σ_{j∈}pₜⱼxₜ^{(j)}, and xₜᵢ is an ith component of the vector xₜ,
a subgradient derivation step of deriving a subgradient gₜ at xₜ of the objective function fₜ, and
a vector update step of updating the vectors xₜ⁽¹⁾, xₜ⁽²⁾, . . . , xₜ^{(d)} in accordance with the following expression (a1) and updating the vector pₜ in accordance with the following expression (a2):

$${y}_{t + 1}^{( j )} = {x}_{t}^{( j )} - {η}^{( j )} {g}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( a1 )$$

where η^{(j)} is a constant determined in accordance with n,

$${w}_{tj} = exp ( - η {\sum }_{τ ∈ [ t ]} {g}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( a2 )$$

where η is a constant determined in accordance with d and T.

### Supplementary Note 7

An information processing apparatus including:
an objective function setting means that sets, as an objective function fₜ in each round t∈[T] (T is any natural number), a submodular function on a power set 2^{S} of a set S consisting of n elements (n is any natural number); and
a subset sequence derivation means that derives a subset sequence X₁, X₂, . . . , X_{T}∈2^{S},
the subset sequence derivation means using (i) a d-dimensional vector pₜ∈[0,1]^{d} (d is a maximum natural number not exceeding 4logT) satisfying |pₜ|=1 and (ii) d n-dimensional vectors xₜ⁽¹⁾, xₜ⁽²⁾, . . . , xₜ^{(d)}∈Rⁿ to carry out, in each round,
a subset derivation step of (1) using a randomly selected uₜ∈[0,1] to derive a subset Xₜ={i∈[n]|xₜᵢ≥uₜ} or (2) using a permutation o on a set [n] satisfying x_{tσ(1)}≥x_{tσ(2)}x_{tσ(n)} and a randomly selected sₜ∈{0,1, . . . ,n} to derive the subset Xₜ={σ(j)|j∈[sₜ]}, assuming that pₜⱼ is a jth component of the vector pₜ, xₜ is an n-dimensional vector defined by xₜ=Σ_{j∈}pₜⱼxₜ^{(j)}, and xₜᵢ is an ith component of a vector tx, the subset Xₜ={i∈[n]|xₜᵢ≥uₜ} being derived with a probability of 1−γ, the subset Xₜ={σ(j)|j∈[sₜ]} being derived with a probability of γ,
an unbiased estimator derivation step of deriving an unbiased estimator \hat{ }gₜ (\hat{ }g is a symbol with ∧ above g) of a subgradient gₜ at xₜ of the objective function fₜ, and
a vector update step of updating the vectors xₜ⁽¹⁾, xₜ⁽²⁾, . . . , xₜ^{(d)} in accordance with the following expression (b1) and updating the vector pₜ in accordance with the following expression (b2):

$${y}_{t + 1}^{( j )} = {x}_{t}^{( j )} - {η}^{( j )} {\hat{g}}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( b1 )$$

where η^{(j)} is a constant determined in accordance with n,

$${w}_{tj} = exp ( - η {\sum }_{τ ∈ [ t ]} {\hat{g}}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( b2 )$$

where η is a constant determined in accordance with n, d, and T.

### Supplementary Note 8

An information processing apparatus including:
an objective function setting means that sets, as an objective function fₜ in each round t∈[T] (T is any natural number), a normalized submodular function on a power set 2^{S} of a set S consisting of n elements (n is any natural number); and
a subset sequence derivation means that derives a subset sequence X₁, X₂, . . . , X_{T} satisfying the following condition β1 or β2:
the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0,
the condition β2 being that the asymptotic behavior of the expected value of the a regret αΣ_{t∈[T]}fₜ(Xₜ*)−Σ_{t∈[T]}fₜ(Xₜ) with respect to the any benchmark X₁*,X₂*, . . . ,Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 9

The information processing apparatus according to Supplementary note 8, wherein
after deriving a subset Xₜ in a round t, the subset sequence derivation means is capable of referring to a value fₜ(X) of the objective function fₜ with respect to any subset X∈2^{S}, and
the function A (k,T,V) is given by the following expression (c):

A(k,T,V)=\sqrt{kT(k+V)} (c)

### Supplementary Note 10

The information processing apparatus according to Supplementary note 9, wherein
the subset sequence derivation means carries out, in the each round t,
a subset derivation step of deriving the subset Xₜ=Xₜₖ by setting Xₜ₀ to Xₜ₀=Ø and then repeatedly carrying out a process for using an element i ts derived from a vector pₜ^{(s)} output by an FSF algorithm execution module FSF*^{(s)} to generate Xₜₛ=X_{t,s-1}∪{iₜₛ}, and
a feed generation step of generating, in accordance with lₜᵢ^{(s)}=fₜ(X_{t,s-1}∪{i})−fₜ(X_{t,s-1})(i∈[n]) , a feed lₜ^{(s)}=(lₜ₁^{(s)},lₜ₂^{(s)}, . . . ,lₜₙ^{(s)}) to be input to the FSF algorithm execution module FSF*^{(s)}.

### Supplementary Note 11

The information processing apparatus according to Supplementary note 8, wherein
after deriving a subset Xₜ in a round t, the subset sequence derivation means is capable of referring to a value fₜ(X) of the objective function fₜ with respect to any subset X∈2S, and
the function B (n,T,V) is given by the following expression (d):

B(n,T,V)=\sqrt{T(1+V/n)} (d)

### Supplementary Note 12

The information processing apparatus according to Supplementary note 11, wherein
the subset sequence derivation means carries out, in the each round t,
a subset derivation step of deriving the subset Xₜ=Xₜₙ=Yₜₙ by repeatedly carrying out a process for (1) setting Xₜ₀ to Xₜ₀=Ø and setting Yₜ₀ to Yₜ₀=[n], (2) using a vector pₜ^{(s)} output by an FSF algorithm execution module FSF*^{(s)} to set qₜ^{(s)} to qₜ^{(s)}=(1+2pₜ₁^{(s)})/4, and (3a) with a probability qₜ^{(s)}, setting Xₜₛ to Xₜₛ=X_{t,s-1}∪{s} and setting Yₜₛ to Yₜₛ=Y_{t,s-1} or (3b) with a probability 1−qₜ^{(s)}, setting Xₜₛ to Xₜₛ=X_{t,s-1} and setting Yₜₛ to Yₜₛ=Y_{t,s-1}\{s}, and
a feed generation step of setting αₜₛ to αₜₛ=fₜ(X_{t,s-1}∪{s})−fₜ(X_{t,s-1}) and setting βₜₛ to αₜₛ=fₜ(Y_{t,s-1}\{s})−fₜ(Y_{t,s-1}), and then generating, in accordance with lₜᵢ^{(s)}=(1−qₜ^{(s)})αₜₛ and lₜ₂^{(s)}=qₜ^{(s)}βₜₛ, a feed lₜ^{(s)}=(lₜ₁^{(s)},lₜ₂^{(s)}) to be input to the FSF algorithm execution module FSF*^{(s)}.

### Supplementary Note 13

An information processing apparatus including:
an objective function setting means that sets, as an objective function fₜ in each round t∈[T] (T is any natural number), a normalized submodular function on a power set 2^{S} of a set S consisting of n elements (n is any natural number); and
a subset sequence derivation means that derives a subset sequence X₁,X₂, . . . ,X_{T}∈2^{S},
the subset sequence derivation means carrying out, in the each round t,
a subset derivation step of deriving a subset Xₜ=Xₜₖ by setting Xₜ₀ to Xₜ₀=Ø and then repeatedly carrying out a process for using an element iₜₛ derived from a vector pₜ^{(s)} output by an FSF algorithm execution module FSF*^{(s)} to generate Xₜₛ=X_{t,s-1}∪{iₜₛ}, and
a feed generation step of generating, in accordance with lₜᵢ^{(s)}=fₜ(X_{t,s-1}∪{i})−fₜ(X_{t,s-1})(i∈[n]) , a feed lₜ^{(s)}=(lₜ₁^{(s)},lₜ₂^{(s)}, . . . ,lₜₙ^{(s)}) to be input to the FSF algorithm execution module FSF*^{(s)}.

### Supplementary Note 14

An information processing apparatus including:
an objective function setting means that sets, as an objective function fₜ in each round t∈[T] (T is any natural number), a normalized submodular function on a power set 2^{S} of a set S consisting of n elements (n is any natural number); and
a subset sequence derivation means that derives a subset sequence X₁, X₂, . . . , X_{T}∈2^{S},
the subset sequence derivation means carrying out, in the each round t,
a subset derivation step of deriving a subset Xₜ=Xₜₙ=Yₜₙ by repeatedly carrying out a process for (1) setting Xₜ₀ to Xₜ₀=Ø and setting Yₜ₀ to Yₜ₀=[n], (2) using a vector pₜ^{(s)} output by an FSF algorithm execution module FSF*^{(s)} to set qₜ^{(s)} to qₜ^{(s)}=(1+2pₜ₁^{(s)})/4, and (3a) with a probability qₜ^{(s)}, setting Xₜₛ to Xₜₛ=X_{t,s-1}∪{s} and setting Yₜₛ to Yₜₛ=Y_{t,s-1} or (3b) with a probability 1−qₜ^{(s)}, setting Xₜₛ to Xₜₛ=X_{t,s-1} and setting Yₜₛ to Yₜₛ=Y_{t,s-1}\{s}, and
a feed generation step of setting αₜₛ to αₜₛ=fₜ(X_{t,s-1}∪{s})−fₜ(X_{t,s-1}) and setting βₜₛ to αₜₛ=fₜ(Y_{t,s-1}\{s})−fₜ(Y_{t,s-1}), and then generating, in accordance with lₜᵢ^{(s)}=(1−qₜ^{(s)})αₜₛ and lₜ₂^{(s)}=qₜ^{(s)}βₜₛ, a feed lₜ^{(s)}=(lₜ₁^{(s)},lₜ₂^{(s)}) to be input to the FSF algorithm execution module FSF*^{(s)}.

### Supplementary Note 15

An information processing method including: setting, as an objective function fₜ in each round t∈[T] (T is any natural number), a submodular function on a power set 2^{S} of a set S consisting of n elements (n is any natural number); and
deriving a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁* ,X₂*, . . . , Xₜ*∈2^{S} satisfying Σ_{t∈[T-1]}d_{H}(Xₜ*,Xₜ₊₁*) is not more than an upper limit Max (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 16

An information processing method including: setting, as an objective function fₜ in each round t∈[T] (T is any natural number), a normalized submodular function on a power set 2^{S} of a set S consisting of n elements (n is any natural number); and
deriving a subset sequence X₁, X₂, . . . , X_{T} satisfying the following condition β1 or β2:
the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₋₁*)≤V coincides with an asymptotic behavior of a function A (k,T,V) determined from k,T,V, assuming that V is a given integer not less than 0,
the condition β2 being that the asymptotic behavior of the expected value of the α regret αΣ_{t∈[T]}fₜ(Xₜ*)−Σ_{t∈[T]}fₜ(Xₜ) with respect to the any benchmark X₁*, X₂*, . . . , Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁* |.

### Supplementary Note 17

A program for causing a computer to operate as an information processing apparatus,
the program causing the computer to function as: an objective function setting means that sets, as an objective function fₜ in each round t∈[T] (T is any natural number), a submodular function on a power set 2^{S} of a set S consisting of n elements (n is any natural number); and a subset sequence derivation means that derives a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁*, X₂*, . . . , Xₜ*∈2^{S} satisfying Σ_{t∈[T-1]}d_{H}(Xₜ*,Xₜ₊₁*) is not more than an upper limit Max (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)−|Xₜ*∪Xₜ₊₁*|−|Xₜ*∩Xₜ₊₁*|.

### Supplementary Note 18

A computer-readable storage medium storing the program according to Supplementary note 17.

### Supplementary Note 19

A program for causing a computer to operate as an information processing apparatus,
the program causing the computer to function as: an objective function setting means that sets, as an objective function fₜ in each round t∈[T] (T is any natural number), a normalized submodular function on a power set 2^{S} of a set S consisting of n elements (n is any natural number); and a subset sequence derivation means that derives a subset sequence X₁, X₂, . . . , X_{T} satisfying the following condition β1 or β2:
the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0,
the condition β2 being that the asymptotic behavior of the expected value of the α regret αΣ_{t∈[T]}fₜ(Xₜ*)−Σ_{t∈[T]}fₜ(Xₜ) with respect to the any benchmark X₁*, X₂*, . . . , Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 20

A computer-readable storage medium storing the program according to Supplementary note 19.

### Supplementary Note 21

An information processing apparatus including at least one processor, the at least one processor carrying out: an objective function setting process for setting, as an objective function fₜ in each round t∈[T] (T is any natural number), a submodular function on a power set 2^{S} of a set S consisting of n elements (n is any natural number); and a subset sequence derivation process for deriving a subset sequence X₁, X₂, . . . , X_{T}∈2^{S} in which an expected value of regret Σ_{t∈[T]}fₜ(Xₜ)−Σ_{t∈[T]}fₜ(Xₜ*) with respect to any benchmark X₁*, X₂*, . . . , Xₜ*∈2^{Ss} satisfying Σ_{t∈[T-1]}d_{H}(Xₜ*,Xₜ₊₁*)≤V is not more than an upper limit Max (n,T,V) determined from n,T,V, assuming that V is a given integer not less than 0, where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 22

An information processing apparatus including at least one processor, the at least one processor carrying out: an objective function setting process for setting, as an objective function fₜ in each round t∈[T] (T is any natural number), a normalized submodular function on a power set 2^{S} of a set S consisting of n elements (n is any natural number); and a subset sequence derivation process for deriving a subset sequence X₁, X₂, . . . , X_{T} satisfying the following condition β1 or β2:
the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0,
the condition β2 being that the asymptotic behavior of the expected value of the α regret αΣ_{t∈[T]}fₜ(Xₜ*)−Σ_{t∈[T]}fₜ(Xₜ) with respect to the any benchmark X₁*, X₂*, . . . , Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

### Supplementary Note 23

Note that any of these information processing apparatuses may further include a memory, which may store a program for causing the at least one processor to carry out the objective function setting process and the subset sequence derivation process. Not also that the program may be recorded in a non-transitory, tangible computer-readable storage medium.

### REFERENCE SIGNS LIST

1, 2 Information processing apparatus
11, 21 Objective function setting unit (objective function setting means)
12, 22 Subset sequence derivation unit (subset sequence derivation means)
S1, S2 Information processing method
S11, S21 Objective function setting process
S12, S22 Subset sequence derivation unit

What is claimed is:

1. An information processing apparatus comprising at least one processor,
the at least one processor carrying out:
an objective function setting process for setting, as an objective function fₜ in each round t∈[T] (T is any natural number), a submodular function on a power set 2^{S} of a set S consisting of n elements (n is any natural number); and
a subset sequence derivation process for deriving a subset sequence X₁,X₂, . . . ,X_{T}∈2^{S} in which an expected value of regret Σ_{t∈[T]}fₜ(Xₜ)−Σ_{t∈[T]}fₜ(Xₜ*) with respect to any benchmark X₁*,X₂*, . . . ,Xₜ*∈2^{S} satisfying Σ_{t∈[T-1]}d_{H}(Xₜ*,Xₜ₊₁*)≤V is not more than an upper limit Max (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

2. The information processing apparatus according to claim 1, wherein
in the subset sequence derivation process, after deriving a subset Xₜ in a round t, the at least one processor is capable of referring to a value fₜ(X) of the objective function fₜ with respect to any subset X∈2^{S}, and
the upper limit Max (n,T,V) is given by the following expression (a):
Max(n,T,V)=4\sqrt{T(n+2V)}+\sqrt{32Tlog(┌logT┐+4)} (a)

3.The information processing apparatus according to claim 2, wherein
in the subset sequence derivation process, the at least one processor uses (i) a d-dimensional vector pₜ∈[0,1]^{d} (d is a maximum natural number not exceeding logT+4) satisfying |pₜ|=1 and (ii) d n-dimensional vectors Xₜ⁽¹⁾,Xₜ⁽²⁾, . . . ,Xₜ^{(d)}∈Rⁿ to carry out, in each round,
a subset derivation step of using a randomly selected uₜ∈[0,1] to derive the subset Xₜ={i∈[n]|xₜᵢ≥uₜ}, assuming that pₜⱼ is a jth component of the vector pₜ, xₜ is an n-dimensional vector defined by xₜ=Σ_{j∈[d]}pₜⱼxₜ^{(j)}, and xₜᵢ is an ith component of the vector xₜ,
a subgradient derivation step of deriving a subgradient gₜ at xₜ of the objective function fₜ, and
a vector update step of updating the vectors xₜ⁽¹⁾,xₜ⁽²⁾, . . . ,xₜ^{(d)} in accordance with the following expression (a1) and updating the vector pₜ in accordance with the following expression (a2):
$${y}_{t + 1}^{( j )} = {x}_{t}^{( j )} - {η}^{( j )} {g}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( a1 )$$
where η^{(j)} is a constant determined in accordance with n,
$${w}_{tj} = exp ( - η {\sum }_{τ ∈ [ t ]} {g}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( a2 )$$
where η is a constant determined in accordance with d and T.

4. The information processing apparatus according to claim 1, wherein
in the subset sequence derivation process, after selecting a subset Xₜ in a round t, the at least one processor is (1) capable of referring to a value fₜ(Xₜ) of the objective function fₜ with respect to the selected subset Xₜ and (2) incapable of referring to a value fₜ(X) of the objective function fₜ with respect to a subset X∈2^{S} that is different from the selected subset, and
the upper limit Max (n,T,V) is given by the following expression (b):
$$Max ( n , T , V ) = γ T + 4 ( n + 1 ) \sqrt{\frac{T}{γ}} ( 2 \sqrt{log log T} + \sqrt{n + V} ) \qquad ( b )$$
where γ is a predetermined constant not less than 0 and not more than 1.

5. The information processing apparatus according to claim 4, wherein
in the subset sequence derivation process, the at least one processor uses (i) a d-dimensional vector pₜ∈[0,1]^{d} (d is a maximum natural number not exceeding 4logT) satisfying |pₜ|=1 and (ii) d n-dimensional vectors xₜ⁽¹⁾,xₜ⁽²⁾, . . . ,xₜ^{(d)}∈Rⁿ to carry out, in each round,
a subset derivation step of (1) using a randomly selected uₜ∈[0,1] to derive the subset Xₜ={i∈[n]|xₜᵢ≥uₜ} or (2) using a permutation σ on a set [n] satisfying x_{tσ(1)}≥x_{tσ(2)}≥. . . ≥x_{tσ(n)} and a randomly selected sₜ∈{0,1, . . . ,n} to derive the subset Xₜ={σ(j)|j∈[sₜ]}, assuming that pₜⱼ is a jth component of the vector pₜ, xₜ is an n-dimensional vector defined by xₜ=Σ_{j∈[d]}pₜⱼxₜ^{(j)}, and xₜᵢ is an ith component of the vector xₜ, the subset Xₜ={i∈[n]|xₜᵢ≥uₜ} being derived with a probability of 1−γ, the subset Xₜ={σ(j)|j∈[sₜ]} being derived with a probability of γ,
an unbiased estimator derivation step of deriving an unbiased estimator \hat{ }gₜ (\hat{ }g is a symbol with ∧ above g) of a subgradient gₜ at xₜ of the objective function fₜ, and
a vector update step of updating the vectors xₜ⁽¹⁾,xₜ⁽²⁾, . . . ,xₜ^{(d)} in accordance with the following expression (b1) and updating the vector pₜ in accordance with the following expression (b2):
$${y}_{t + 1}^{( j )} = {x}_{t}^{( j )} - {η}^{( j )} {\hat{g}}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( b1 )$$
where η^{(j)} is a constant determined in accordance with n,
$${w}_{tj} = exp ( - η {\sum }_{τ ∈ [ t ]} {\hat{g}}_{t}^{T} {x}_{τ}^{( j )} ) ( j ∈ [ d ] ) , {p}_{t + 1} = \frac{{w}_{t}}{{‖ {w}_{t} ‖}_{1}} \qquad ( b2 )$$
where η is a constant determined in accordance with n, d, and T.

6. An information processing apparatus comprising at least one processor,
the at least one processor carrying out:
an objective function setting process for setting, as an objective function fₜ in each round t∈[T] (T is any natural number), a submodular function on a power set 2^{S} of a set S consisting of n elements (n is any natural number); and
a subset sequence derivation process for deriving a subset sequence X₁,X₂, . . . ,X_{T}∈2^{S},
in the subset sequence derivation process, the at least one processor using (i) a d-dimensional vector pₜ∈[0,1]^{d} (d is a maximum natural number not exceeding logT+4) satisfying |pₜ|=1 and (ii) d n-dimensional vectors xₜ⁽¹⁾, xₜ⁽²⁾, . . . , xₜ^{(d)}∈Rⁿ to carry out, in each round,
a subset derivation step of using a randomly selected uₜ∈[0,1] to derive a subset Xₜ={i∈[n]|xₜᵢ≥uₜ}, assuming that pₜⱼ is a jth component of the vector pₜ, xₜ is an n-dimensional vector defined by xₜ=Σ_{j∈[d]}pₜⱼxₜ^{(j)}, and xₜᵢ is an ith component of the vector xₜ,
a subgradient derivation step of deriving a subgradient gₜ at xₜ of the objective function fₜ, and
a vector update step of updating the vectors xₜ⁽¹⁾, xₜ⁽²⁾, . . . , xₜ^{(d)} in accordance with the following expression (a1) and updating the vector pₜ in accordance with the following expression (a2):
$${y}_{t + 1}^{( j )} = {x}_{t}^{( j )} - {η}^{( j )} {g}_{t} , {x}_{t}^{( j )} ∈ arg {min}_{x ∈ {[ 0 , 1 ]}^{n}} {‖ x - {y}_{t + 1}^{( j )} ‖}_{2}^{2} \qquad ( a1 )$$
where η^{(j)} is a constant determined in accordance with n,
$${w}_{tj} = exp ( - η {\sum }_{τ ∈ [ t ]} {g}_{τ}^{T} {x}_{τ}^{( j )} ) ( j ∈ [ d ] ) , {p}_{t + 1} = \frac{{w}_{t}}{{‖ {w}_{t} ‖}_{1}} \qquad ( a2 )$$
where η is a constant determined in accordance with d and T.

7. (canceled)

8. An information processing apparatus comprising at least one processor,
the at least one processor carrying out:
an objective function setting process for setting, as an objective function fₜ in each round t∈[T] (T is any natural number), a normalized submodular function on a power set 2^{S} of a set S consisting of n elements (n is any natural number); and
a subset sequence derivation process for deriving a subset sequence X₁,X₂, . . . ,X_{T} satisfying the following condition β1 or β2:
the condition β1 being that each subset Xₜ satisfies |Xₜ|≤k assuming that k is a given natural number and that an asymptotic behavior of an expected value of α regret αΣ_{t∈[T]}fₜ(Xₜ*)−Σ_{t∈[T]}fₜ(Xₜ) with respect to any benchmark X₁*, X₂*, . . . , Xₜ*∈2^{S} satisfying |Xₜ*|≤k and Σ_{t∈[T-1]}d_{H}(Xₜ*,Xₜ₊₁*)≤V coincides with an asymptotic behavior of a function A (k,T,V) determined from k,T,V, assuming that V is a given integer not less than 0,
the condition β2 being that the asymptotic behavior of the expected value of the α regret αΣ_{t∈[T]}fₜ(Xₜ*)−Σ_{t∈[T]}fₜ(Xₜ) with respect to the any benchmark X₁*, X₂*, . . . , Xₜ*∈2^{S} satisfying Σ_{t∈[T-1]}d_{H}(Xₜ*,Xₜ₊₁*)≤V coincides with an asymptotic behavior of a function B (n,T,V) determined from n,T,V, assuming that V is a given integer not less than 0,
where d_{H}(Xₜ*,Xₜ₊₁*) is a Hamming distance between subsets, the Hamming distance being defined by d_{H}(Xₜ*,Xₜ₊₁*)=|Xₜ*∪Xₜ₊₁*|−|Xₜ*∩Xₜ₊₁*|.

9. The information processing apparatus according to claim 8, wherein
in the subset sequence derivation process, after deriving a subset Xₜ in a round t, the at least one processor is capable of referring to a value fₜ(X) of the objective function fₜ with respect to any subset X∈2^{S}, and
the function A (k,T,V) is given by the following expression (c):
A(k,T,V)=\sqrt{kT(k+V)} (c)

10. The information processing apparatus according to claim 9, wherein
in the subset sequence derivation process, the at least one processor carries out, in the each round t,
a subset derivation step of deriving the subset Xₜ=Xₜₖ by setting Xₜ₀ to Xₜ₀=Ø and then repeatedly carrying out a process for using an element iₜₛ derived from a vector pₜ^{(s)} output by an FSF algorithm execution module FSF*^{(s)} to generate Xₜₛ=X_{t,s-1}∪{iₜₛ}, and
a feed generation step of generating, in accordance with lₜᵢ^{(s)}=fₜ(X_{t,s-1}∪{i})−fₜ(X_{t,s-1})(i∈[n]), a feed lₜ^{(s)}=(lₜ₁^{(s)},lₜ₂^{(s)}, . . . ,lₜₙ^{(s)} to be input to the FSF algorithm execution module FSF*^{(s)}.

11. The information processing apparatus according to claim 8, wherein
in the subset sequence derivation process, after deriving a subset Xₜ in a round t, the at least one processor is capable of referring to a value fₜ(X) of the objective function fₜ with respect to any subset X∈2^{S}, and
the function B (n,T,V) is given by the following expression (d):
B(n,T,V)=\sqrt{T(1+V/n)} (d)

12. The information processing apparatus according to claim 11, wherein
in the subset sequence derivation process, the at least one processor carries out, in the each round t,
a subset derivation step of deriving the subset Xₜ=Xₜₙ=Yₜₙ by repeatedly carrying out a process for (1) setting Xₜ₀ to Xₜ₀=Ø and setting Yₜ₀ to Yₜ₀=[n], (2) using a vector pₜ^{(s)} output by an FSF algorithm execution module FSF*^{(s)} to set qₜ^{(s)} to qₜ^{(s)}=(1+2pₜ₁^{(s)})/4, and (3a) with a probability qₜ^{(s)}, setting Xₜₛ to Xₜₛ=X_{t,s-1}∪{s} and setting Yₜₛ to Yₜₛ=Y_{t,s-1} or (3b) with a probability 1−qₜ^{(s)}, setting Xₜₛ to Xₜₛ=X_{t,s-1} and setting Yₜₛ to Yₜₛ=Y_{t,s-1}\{s}, and
a feed generation step of setting αₜₛ to αₜₛ=fₜ(X_{t,s-1}∪{s})−fₜ(X_{t,s-1}) and setting βₜₛ to βₜₛ=fₜ(Y_{t,s-1}\{s})−fₜ(Y_{t,s-1}), and then generating, in accordance with lₜᵢ^{(s)}=(1−qₜ^{(s)})αₜₛ and lₜ₂^{(s)}=qₜ^{(s)}βₜₛ, a feed lₜ^{(s)}=(lₜ₁^{(s)},lₜ₂^{(s)}) to be input to the FSF algorithm execution module FSF*^{(s)}.

13-14. (canceled)
